(19) United States
(12) Patent Application Publication
(10) Pub. No.: US 2007/0181614 A1
(43) Pub. Date: Aug. 9, 2007

(54) Measuring particulate material dispenser

(76) Inventors: Michailo Rvachov, Windsor (CA); Marat Rvachov, Brooklyn, NY (US)

Correspondence Address: Michailo Rvachov, 2342 Santo Dr., Windsor, ON, N9G 2J6, CA

(21) Appl. No.: 11/348,043

(22) Filed: Feb. 5, 2006

(51) Int. Cl. G01F 11/26

(52) U.S. Cl. 222/456

(57) ABSTRACT

A container for dry particulate material, such as tablets or pills, beans, cereals, coffee, sugar, fish food, fertilizer, bleach powder etc, which, when it is turned upside down, dispenses a customer defined volume amount of material, or a predefined number of pills (e.g., one pill at a time).

### CROSS-REFERENCE AND RELATED APPLICATIONS

This application claims the benefit of the provisional application 60/635,185 filed Feb. 15, 2005 by the first named present inventor Michailo Rvachov.

### FEDERALLY SPONSORED RESEARCH

Not Applicable

### SEQUENCE LISTING OR PROGRAM

Not Applicable

### FIELD OF THE INVENTION

This invention relates to the dispensing of dry particulate material, and in particular, to dispensing of a required volume, amount or number of granules of dry particulate (granules, powders, flakes etc) material.

### BACKGROUND OF THE INVENTION

This invention relates to the dispensing of a required volume, amount or number of granules of dry particulate (granules, powders, flakes etc) material, such as tablets or pills, beans, cereals, coffee, sugar, fish food, fertilizer, bleach powder etc. In particular, the invention concerns a dispenser apparatus in a container such as a pill bottle or vial to dispense one pill at a time. The invention also concerns the dispenser in a container such a cereal, instant coffee or coffee-mate etc package, to dispense easily the amount selected by the consumer, without contaminating and exposing to the open air the remaining material, whereas the package can be made of cardboard, plastics, glass etc.

Among the large variety of the containers supplied with means to dispense a measured amount of the material, there is a distinct class where to dispense the measured amount the consumer needs just to turn the container partially or fully upside down (the dispensing position); no other manipulations by the consumer are required. Some of the inventions that represent this class are described in U.S. Pat. Nos. 5,135,138; 4,938,394; 4,871,095; 4,667,857; 4,424,921; 3,738,544; 3,298,576; 3,235,144; 2,896,826; 2,393,262; 2,676,734; 2,538,336; 2,425,142; 2,335,363; 2,309,234; 1,877,808; 1,261,072; 907,291. All mentioned inventions elaborate the same basic idea: there is a measuring chamber of a specific size located below the main storage chamber; when the container is in an upright (storage) position the measuring chamber is being filled through the filling aperture(s) with the material flowing under the gravity from the storage chamber. When the container is being turned into the dispensing position, the material flows from the measuring chamber through the dispensing (delivery) passage out of the container. The material does not flow back into the storage chamber through the filling aperture(s), or this flow is very limited, because of the size, shape and location of the aperture(s) and, in some of the inventions, the way how the container is being tilted into the dispensing position. The dispensing passage goes from the measuring chamber at the bottom of the container up to the top of the container where the dispensing passage ends up as a dispensing opening from which the material is being dispensed out of the container. This provides a convenience of usage, because in the dispensing position the dispensing opening becomes the lowest place of the container, so that the other parts of the container will not interfere with the location into which the material is being dispensed.

The containers of this class are easy to use (each dispensing cycle can be performed with one hand), they do not allow accidental dispensing or uncontrollable flow of the material out of the container and assert that the bulk of the material in the storage chamber is not exposed to the contamination and the fresh air, which is important for the air-sensitive products, e.g., to preserve the freshness of coffee or baby-food formula etc.

However, there are several intrinsic problems associated with the aforementioned inventions.

“There is a tendency for the material in the delivery passage to rise to the level of the material of the main body” (quote from U.S. Pat. No. 2,393,262). In general, the approach relies on the inner friction between the particles of the material to assure that the measuring chamber is filled to the required level. In some of the inventions; there is a direct reference to the repose angle as a characteristic that defines how much the measuring chamber will be filled (U.S. Pat. Nos. 4,938,394; 4,201,320). However, the repose angle is a static characteristic, while the container is being used dynamically. The general trend to overcome this problem was to make each filling aperture smaller, while making the number of the apertures bigger, to increase the aperture passing resistance; and/or to flare the apertures walls in the proper direction; and/or to make the dispensing passage narrower, to reduce the measuring error due to uncontrolled filling of the passage; and/or to introduce interim chamber(s) between the measuring chamber and the storage chamber, to control better the amount of the material passing into the measuring chamber. However, besides the positive effect, these means lead to a possibility of clogging of the filling apertures, dispensing passage or interim chamber(s). To release the clogging, the consumer will have to shake or tap the container, which, again, will lead to the failure of measuring.

It is an object of this invention to provide a container of the class described above that benefits of dynamic usage, like shaking or tapping, and provides measuring (compare to U.S. Pat. Nos. 5,232,130; 5,169,049 that use shaking to control the dispensing amount, but do not provide measuring).

Another problem related to the aforementioned inventions is the easiness of changing the measured amount of the material released during each dispensing operation. Though the possibility to change the measured released amount is embedded into many of the inventions of this class (e.g., U.S. Pat. Nos. 4,424,921; 2,896,826; 2,425,142; 2,335,363; 1,877,808; 907,291), setting the size of the measuring chamber is a separate procedure of tuning the container, which requires a special attention, both hands of the consumer and, in some of the inventions, can be performed only upfront, before the container is filled with the material.

It is another object of this invention to provide the consumer with a way to decide “on a fly” how much of the material should be dispensed, without any special tuning of the container, with the same level of flexibility as it is provided for the dispensing of liquids in the Jennings' series of the containers (U.S. Pat. No. 6,290,102 etc), or, for the dry particulate materials, in the invention U.S. Pat. No. 5,518,152 (though the latter one does not belong to the described above class and needs more steps for each dispensing cycle).

Another missed opportunity for the containers of the described class is application of the approach to the dispensing of a predefined number of granules of the same shape and size, like dispensing required number of medical pills, e.g., one pill at a time. The dispensing of medical pills one at a time is subject on many inventions. In some of them the consumer has to rotate the vial cap in the upside down position (U.S. Pat. Nos. 6,860,403; 5,791,515). This presumes some mobility of the consumer's fingers, which is not always available. If a pill became jammed it can be squashed, because nothing limits the force that can be applied to it when the cap is being rotated. In other inventions the consumer loads a shelf at the top of the vial with a pill by turning the vial upside down (U.S. Pat. Nos. 4,530,447; 4,454,962). If the consumer does not close the cap before loading the shelf or does not cover the shelf with his/her finger, uncontrollable flow of the pills out of the container will occur.

It is another object of this invention to provide a container that will dispense one pill (or predefined number of pills) each time when the container is tipped upside down into the dispensing position.

### BRIEF SUMMARY OF THE INVENTION

The present invention has two versions, for dispensing of the particulate material measured by volume and for dispensing of the particulate material measured by count of particles like pills, granules etc.

When measured by volume, to overcome the disadvantages of the prior art the container comprises two chambers, the storage chamber and the measuring chamber, whereas the measuring chamber might extend to or above the height of the storage chamber. The measuring chamber and the storage chamber are connected by an aperture in their lower parts, through which aperture the particulate material can pass between the chambers. When the container is ready for usage (is not in the initial loading/assembly phase), the storage chamber does not have any other ways, than said aperture, through which the material can be moved in or out of it, while the measuring chamber has a dispensing opening in its upper part, which leads outside the container. Though the measuring chamber and the storage chamber are connected by the aperture, the level of the material in the measuring chamber can be more, same or less than the level of the material in the storage chamber, because of the inner fiction between the particles of the material, which constrains penetration of the material through the aperture. The measuring chamber is provided with means that allow the consumer to know how much material is in the chamber, e.g. it has a transparent wall, which wall might have metering marks that correspond specific volumes (like a teaspoon marks, a cup marks etc). The consumer can change the amount of the material in the measuring chamber by tilting the container towards the measuring chamber, to increase the amount, or in the opposite direction, to decrease the amount, and agitating the material by shaking or tapping the container, which agitation facilitates the penetration of the material through the aperture. The aperture might be furnished with specific means, like a baffle, a visor and/or a chute, to facilitate the penetration of the material, when the container is being shaken, and to prevent the penetration, when it is not being shaken. When the amount of the material in the measuring chamber is as required, the consumer tips the container to make the dispensing opening the lowest point of the measuring chamber, and the required amount of the material pours out of the measuring chamber and out of the container.

Measuring by count can be achieved when all the material particles are of the same shape and size, like, e.g., medical pills. The part of the measuring chamber located below the aperture, the measuring bunker, is shaped to contain the exact number of the pills (e.g., exactly 1 pill, or exactly 2 pills, etc). The part of the chamber located above the aperture is not used for measuring and serves as a dispensing channel. The aperture is shaped to allow passage of only one pill at a time. The measuring chamber and the aperture are shaped so that a pill cannot go from the aperture into the measuring chamber, when the measuring bunker is fully filled with pills, because the topmost pill in the measuring bunker serves as a plug that does not let in the pill from the aperture. The measuring chamber and the aperture are also shaped so that the topmost pill in the bunker cannot move up, when there is a pill in the aperture, because, in its turn, the pill in the aperture serves as a plug that does not allow the topmost pill go up. This mutual locking of the topmost pill in the bunker and the pill in the aperture asserts that no pills can be loaded into the measuring chamber above the aperture, even if the container is being shaken or while it is being tipped over. When the container is tipped into the dispensing position, first the pill in the aperture falls back into the storage chamber, releasing the pill(s) in the measuring bunker to fall through the measuring chamber out of the container.

### BRIEF DESCRIPTION OF THE DRAWINGS

The description herein makes reference to the accompanying drawings wherein like reference numbers refer to like parts throughout the several views, and wherein:

FIG. 1 is a principle scheme of the container with the measuring dispenser in the rest position;

FIG. 2 is a scheme of the container positioned to increase the amount of the material in the measuring dispenser while shaking;

FIG. 3 is a scheme of the container positioned to decrease the amount of the material in the measuring dispenser while shaking;

FIG. 4 is a scheme of the container in the dispensing position;

FIGS. 5 and 6 are principle schemes of the container with the measuring dispenser designed to dispense an exact number of pills (tablets);

FIG. 7 is a scheme of the container designed to dispense an exact number of pills and supplied with a lock that prevents inadvertent loading of the measuring chamber, if the container is accidentally turned over (e.g., in the consumer's pocket).

FIG. 8 is a principle scheme of the container with the measuring chamber and the storage chamber manufactured separately and assembled at the final production stage or by the consumer;

FIGS. 9 and 10 are schemes of the container with the measuring chamber and the storage chamber supplied to the consumer separately;

FIG. 11 is a principle scheme of the container with a temper-proof valve and a version of a frugal design of the measuring bunker and the storage chamber floor; and

FIG. 12 is a principle scheme of the container with a magazine of the measuring bunkers, for adjusting the number of the pills released in one dispensing cycle.

### DETAILED DESCRIPTION OF THE INVENTION

The present invention discloses a dispensing container 1 comprising a main storage chamber 3 and a measuring-dispensing chamber 2, a measuring dispenser. The storage chamber 3 is filled with the material 6 during the production or initial loading, after which the chamber 3 is sealed, with the exception of an aperture 4 that leads to the measuring dispenser 2. The measuring dispenser 2 is also connected to the dispensing opening or spout 7 that leads outside the container 1. The wall 8 of the measuring dispenser 2 can be transparent, in which case it can have metering marks that correspond a specific volume (e.g., teaspoon or cup marks). The measuring dispenser 2 can have a lower portion 9 located below the aperture 4, a measuring bunker. The measuring bunker 9 defines the minimum amount of material being dispensed in one dispensing cycle. The floor of the storage chamber 3 can be tilted and can have a chute, to facilitate sliding of the material 6 towards the aperture 4.

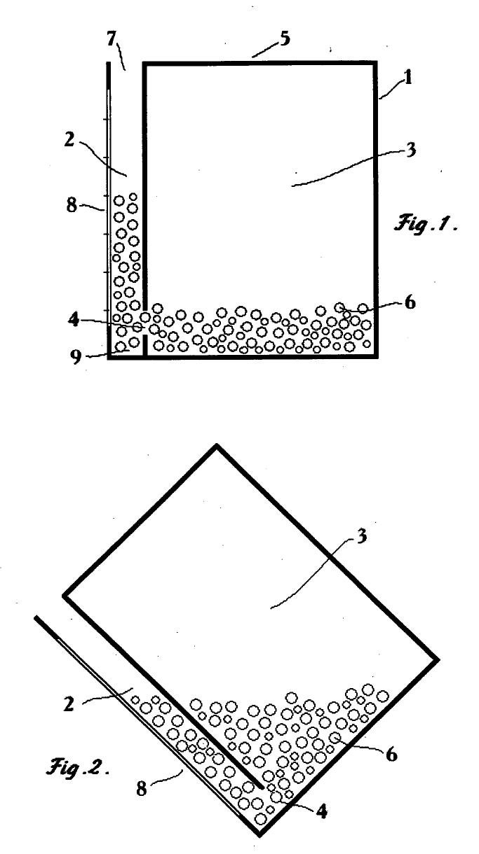

Referring now to FIG. 1, in the upright (rest) position of the container 1 the level of the dry particulate material (powder, flakes, tablets, capsules etc) 6 in the dispenser 2 and the storage chamber 3 can be different, though they are connected by the aperture 4, because of the inner fiction between the particles (opposed to a liquid material).

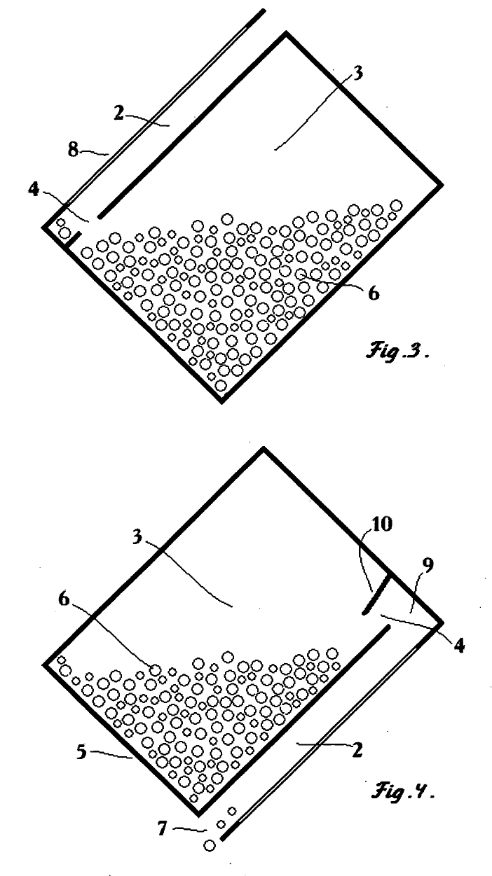

As illustrated in FIGS. 2 and 3, shaking or tapping of the container 1 in a properly tilted position allows increasing or decreasing of the amount of the material 6 inside the dispenser 2, provided that the material particles are small enough vs the size of the aperture 4. In some embodiments, the amount of the material inside the dispenser 2 can be visually controlled through the transparent wall 8.

Referring now to FIG. 4, when the amount of the material in the measuring dispenser 2 is as needed, the consumer turns the container into the dispensing position, shown on the figure. In the dispensing position all the material 6 that was inside the dispenser 2 falls out through the dispensing opening or spout 7, while the walls of the storage chamber 3, including the upper wall 5, retain the material 6 that was inside the storage chamber. The container may comprise a baffle 10, to reduce the amount of material that can move from the storage chamber 3 into the dispenser 2 while the container is being tilted into the dispensing position.

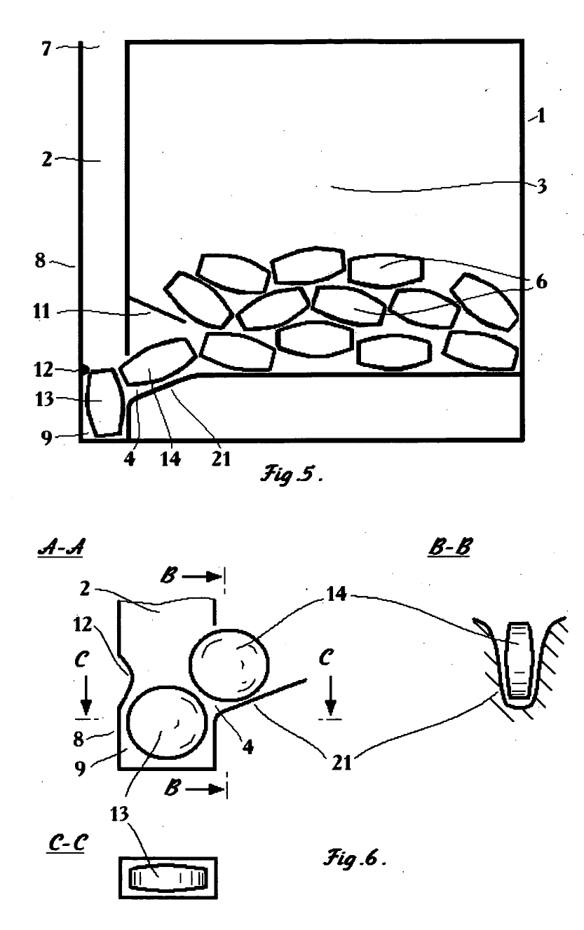

Referring now to FIGS. 5 and 6, if the material 6 consists of pieces of the same shape and size, like tablets, capsules, pills etc, called below pills, the shape of the aperture 4 and of the measuring bunker 9 can be made to accommodate the exact required number of the pills (in both FIGS. 5 and 6 it is just one pill). For this the aperture 4 is shaped to let through only one pill at a time, in a preferred orientation; the bunker 9 is shaped to collect the pills in an organized way as they pass through the aperture 4 in the preferred orientation and the storage chamber floor 21 can be formed to create a chute that will facilitate sliding of the pills into the aperture 4 in the preferred orientation.

FIGS. 5 and 6 show that the preferred orientation can be different for the pills of the same shape; at the FIG. 5 for the most common shape of the medical pills the preferred orientation is “natural” while at the FIG. 6 the preferred orientation for the same shape pills is “on edge”.

When the container 1 is in the rest position, the pills fall from the storage chamber 3 through the aperture 4 into the dispenser 2, until the bunker 9 is full. The dispenser wall 8 has an inwardly directed bulge 12, a stopper, located in front of the aperture 4, so that the gap between the stopper 12 and the aperture 4 (the opposite walls of the dispenser 2) is smaller than the size of the pill 13 in the corresponding direction and, at the same time, the space in front the stopper 12 of the dispenser 2, including the aperture 4 space, is large enough to accommodate the pill. When the container is in the upright position, the topmost pill 13 in the bunker 9 partially plugs the aperture 4, so that the pill 14 in the aperture cannot move into the dispenser 2. In its turn, the pill 14 in the aperture and the stopper 12 partially plug the dispenser 2, so that the pill 13 cannot move above the stopper 12, even if the container is being shaken, if there is a pill in the aperture 4. This asserts that the dispenser cannot be loaded with the pills above the stopper 12.

When the container 1 is tilted into the dispensing position, the pill 13 cannot move along the dispenser 2 until the pill 14 falls back into the storage 3 and releases the aperture 4. After this the pill 13 dodges around the stopper 12, using the space of the aperture 4, and slides along the dispenser 2 and out of the dispensing opening 7 (if the bunker 9 is made to accommodate more than one tables, they slide out too). This asserts that no pills can slip through the aperture 4 when the container is being tilted into the dispensing position and no extra pills will be released.

When the storage chamber 3 is filled with many layers of the pills, under the weight of the upper layers the pills near the storage floor/chute 21 tend to jam, which may need more shaking to re-orient them correctly to slip through the aperture 4. A visor 11 can be provided above the aperture 4, to release the pressure of the upper layers of the pills and facilitate sliding of the pills in the proper orientation towards the aperture. The visor 11 can be made of a flexible or pliable material and/or can be loosely attached to the container, so that the visor will have some movement under the weight of the pills when the container is tipped into the dispensing position and backwards. This asserts that no pills will stuck or jam between the visor 11 and the floor 21.

When the container 1 is made to dispense the predefined number of the pills, as shown at FIGS. 5 and 6, there is no need to make the wall(s) of the dispenser 2 transparent, since the number of the dispensed pills is defined by the size of the bunker 9.

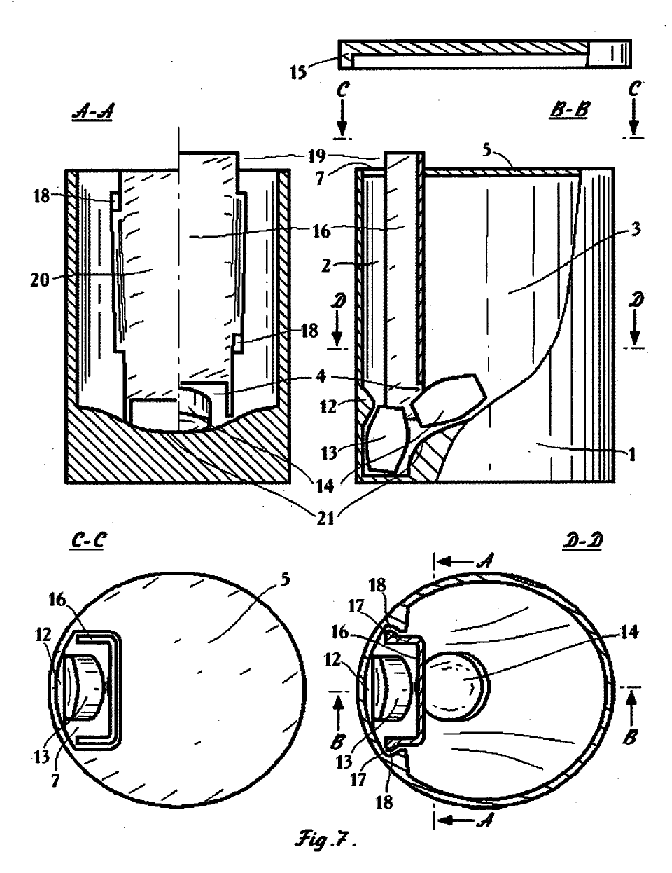

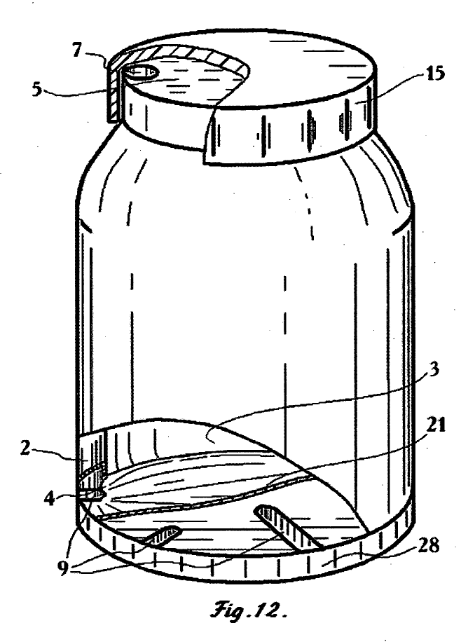

The container 1 can be supplied with an external lid 15 (FIGS. 7 and 12), to close the dispensing opening 7 when the container is not in use.

When the container is supplied with the lid 15 and is used to dispense the pills by number, if the container is tipped into the dispensing position with the lid 15 closed, the pill in the dispenser 2 will not be released out of the container, but will remain in the dispenser 2. When the container is returned into the upright position, it may happen that a pill from the storage 3 will fall into the bunker 9 before the pill that was already in the dispenser 2 will fall into the bunker 9. This way the dispenser 2 can be loaded with more pills than required, if the container is turned over with the lid 15 closed. The random turning over of the container may occur, e.g., when the container is being carried in the consumer's pocket.

If the dispenser 2 is provided with the transparent wall, the consumer can visually control the number of the pills in the dispenser and, if it is more than needed, unload extra pills by shaking the container in the position shown at FIG. 3. However, it is preferable to have a version of the pill-dispensing container that does not require a visual control at all. It can be achieved if the aperture 4 is automatically closed or reduced when the lid 15 is closed.

Referring now to FIG. 7, the dispensing chamber 2 is separated from the storage chamber 3 by a movable wall 16. The opposite sides 17 of the movable wall 16 have bulges, which elastically snap into corresponding grooves 18 in the container walls. In the vertical direction, the grooves 18 are longer than the matching parts of the movable wall 16, which allows the wall 16 to move up and down vs the container 1 within some distance; 16 denotes the up-most position of the wall, while 20 refers to its lowest position. The grooves 18, as well as the opposite sides 17, are not parallel, but slightly converge towards each other at the bottom of the container 1. This forces the sides 17 to elastically bend in, when the wall 16 is pushed into its lower position 20. When the wall 16 is not pushed down, the springback of the sides 17 forces wall 16 to move to its up-most position. The wall 16 has a part 19, a stock, which sticks out of the opening 7 above the container wall 5, when the wall 16 is above its lowest position 20. When the lid 15 closes the container, it pushes the stock 19 and forces the wall 16 into its lowest position 20; while when the lid is removed, the springback forces wall 16 into its up-most position. The aperture 4 is formed as a gap between the movable wall 16 and the container floor 21. When the lid 15 closes the container, the aperture 4 is closed or reduced, so that a pill cannot penetrate from the storage chamber 3 into the dispenser 2, when the lid 15 is on, even if the container is inadvertently turned over.

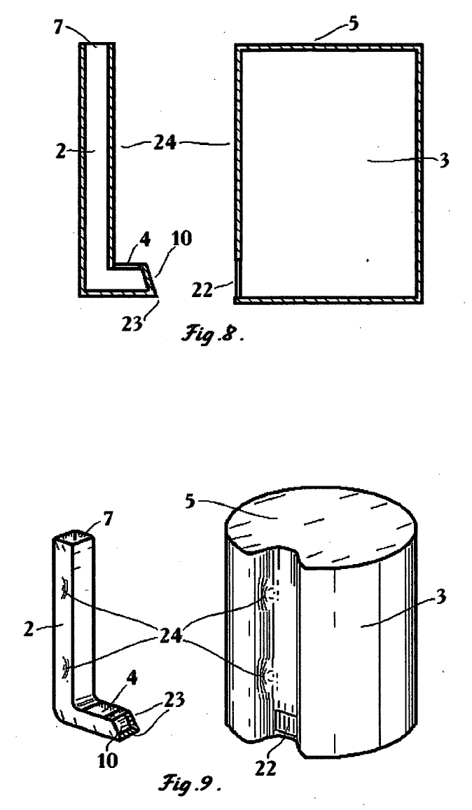

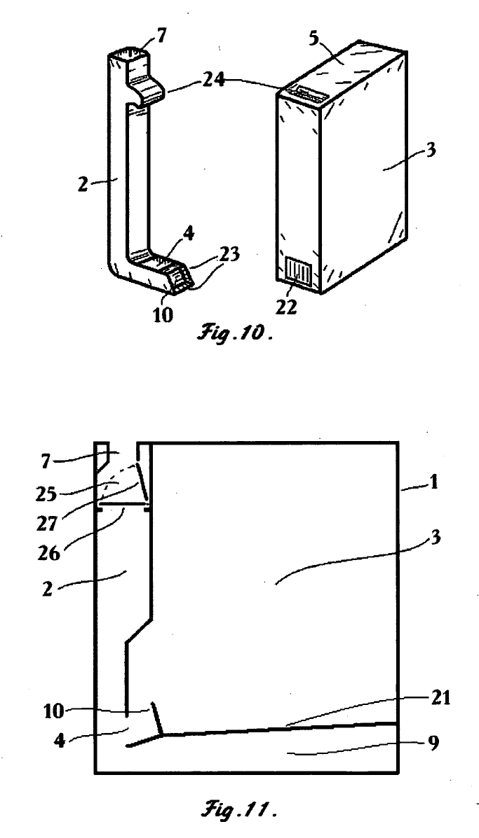

Referring now to FIG. 8, the measuring dispenser 2 and the storage chamber 3 can be produced as standalone pieces. This may simplify and cheapen the production, e.g., the dispenser 2 can be made of a transparent plastic while the storage made of a cheaper material. In some implementations, the dispenser 2 can be made for multiple uses with different storage chambers 3. The standalone dispenser 2 can comprise the baffle 10 and the aperture 4. The standalone dispenser 2 and storage 3 are assembled so that corresponding walls 24 will adhere to each other, while the lower part of the dispenser 2 will move inside the chamber 3 through a matching opening 22. If the assembly of the parts 2 and 3 is done during the production, the walls 24 adhere permanently (e.g., glued together). If the consumer does the assembly of the dispenser 2 and the storage 3, during the production the opening 22 is ready-to-punch closed and the storage 3 is filled with the material. Referring now to FIGS. 8, 9 and 10, the consumer punches the door 22 with the sharp edges 23 of the dispenser 2; the punched out piece of the door can be retained in the recess between the edges 23 and the baffle 10. The consumer snaps matching grooves and bulges 24 on the dispenser 2 and storage 3, so that they will by firmly joined, after which the container is ready to use.

Referring now to FIG. 11, the dispenser 2 can have a temper-proof valve 25. In the dispensing position of the container 1, the valve door will open, the opened door 27, under the door's weight and the weight of the material, and will allow free dispensing of the material from the dispenser 2 through the spout 7. In the rest position of the container 1, the valve door will close under its weight, the closed door 26, so that no material can be added back into the container.

The valve 25 can be designed without moving parts as a maze-shaped channel with a trap that will not allow loading the dispenser 2 with material through the spout 7.

The FIG. 11 also illustrates that the measuring bunker can be positioned under the storage chamber floor 21, to save space.

In some embodiments, the size of the measuring bunker 9 can be adjustable, to dispense required number of the pills or modify the minimum volume of the dispensed material. An insert into the bunker (a piston) that can be moved into a desired position by the consumer can control the amount of the material in the bunker 9. Another way to change the size of the bunker is illustrated in FIG. 12. The container 1 can have a dial 28 that contains several bunkers 9 of different sizes, located under the floor 21 of the storage chamber 3. Only one of the bunkers 9 is connected at a time to the dispenser 2. The consumer can set which one of the bunkers 9 is connected to the dispenser by rotating the dial 28.

The FIG. 12 also illustrates that the container 1 can have a regular cap 15, e.g. a child resistant cap, whereas after removing the cap 10 the main chamber 3 is remained closed by the upper wall 5.

While the invention has been described in connection with what is presently considered to be the most practical and preferred embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A measuring container for dispensing of a measured amount of a granular/particulate material or number of the particulate material granules at a time which comprises of two chambers, a storage chamber and a measuring chamber; said storage chamber holds the bulk amount of the particulate material; said storage chamber is closed with the exception of an aperture in its lower part that connects it with the lower part of the said measuring chamber; said aperture is large enough to allow passing of the particulate material between said storage chamber and said measuring chamber, when said container is being shaken, whereas the direction of the material passing, from said storage chamber to said measuring chamber or backwards, depends on which way said container is tilted; said measuring chamber has a dispensing opening or spout in its upper part for dispensing the material out of said container, when said container is being turned into the dispensing position; said dispensing position is when the container is fully or partially upside down; said measuring chamber might have a part located below said aperture, a measuring bunker; said measuring bunker defines the minimum amount of the material or number of granules being dispensed at a time.

2. Measuring container according to claim 1 wherein said measuring chamber has a transparent wall through which the amount on the material in said measuring chamber can be observed by the consumer; said transparent wall might have metering marks to indicate the amount of the material below each mark.

3. Measuring container according to claim 1 wherein the granules being dispensed, referred hereafter as pills, are of the same shape and size; said aperture has shape and size such that only one pill can pass through it at a time; said measuring chamber comprises an inwardly extending budge located in front of the said aperture, a stopper; said stopper and said aperture have shapes and sizes such that a pill can be moved inside said measuring chamber from the position below said stopper to the position above said stopper when said aperture does not have another pill in it, and a pill cannot be moved inside said measuring chamber from the position below said stopper to the position above said stopper when there is another pill in said aperture, because the gap between said stopper and the pill in said aperture is too small; said shapes and sizes of said stopper and said aperture assert that no pill can be loaded from said storage chamber into said measuring chamber above said stopper; said shapes and sizes of said stopper and said aperture also assert that when said container is being turned into the dispensing position the dispensing of the pills from said measuring chamber will not start until said storage chamber side of said aperture is free of the pills, so that no extra pill can slip through said aperture into said measuring chamber during the dispensing.

4. Measuring container according to claim 1 wherein said storage chamber comprises a chute or spout that leads to said aperture, to facilitate passing of the particulate material from said storage chamber into said measuring chamber.

5. Measuring container according to claim 1 wherein said storage chamber comprises a visor or shade, located above said aperture; said visor or shade holds part of the particulate material above it and protects the particulate material near said aperture from jamming, when said container is in upright position.

6. Measuring container according to claim 5 wherein said visor or shade is made to give in and not hold the material that will be above it, when said container is turned into the dispensing position; said behavior is produced by making said visor or shade of a pliable or flexible material, or by hinged attachment of said visor or shade to the walls of said storage chamber or by other means.

7. Measuring container according to claim 1 wherein said storage chamber comprises an inner wall, a baffle, located near said aperture and oriented approximately the same as said aperture; said baffle prevents the penetration into said aperture of the particulate material located on the other side of said baffle than said aperture, when said container is being tilted into the dispensing position.

8. Measuring container according to claim 1 wherein said measuring chamber comprises a one-way valve; said valve does not allow a material to be loaded into said measuring chamber through said opening or spout, designated for dispensing the material out of said container; said valve allows free dispensing of the said particulate material out of said container, when said container is being turned into the dispensing position.

9. Measuring container according to claim 1 wherein said measuring bunker is adjustable, either by changing the size of said bunker or by replacing said bunker by a different bunker out of a plurality of bunkers, to hold different amount of the particulate material or number of the particulate material granules.

10. Measuring container according to claim 1 wherein said container comprises means to partially of fully close said aperture, to prevent passing of the material from said storage chamber into said measuring chamber.

11. Measuring container according to claim 10 wherein said container is supplied with a removable top or cap for covering said dispensing opening or spout, when the container is not used for dispensing; said aperture is a gap between an inner movable wall of the said container and an inner immobile wall of said container; said moveable wall can move up and down by a distance comparable to the height of said aperture; said gap being opened when said moveable wall moves up and said gap being fully or partially closed when said moveable wall moves down; said movable wall having upper ridge extending outward of said container, so that said upper ridge can be pressed from outside said container; said movable wall being elastically supported by or attached to said container, so that it moves down, when said upper ridge is being pressed, and it moves up, when said upper ridge is not pressed; said upper ridge is being pressed by said cap, when said cap closes said container, so that said aperture will be fully or partially closed, when said container is closed by said cap, to prevent loading of the material into said measuring chamber, if said container is being inadvertently turned upside down, e.g., in the consumer's pocket; said upper ridge is not pressed and is free, when said cap if taken off and said container is opened, so that said aperture also will be opened.

12. Measuring container according to claim 1 wherein said storage chamber and said measuring chamber are produced as standalone parts that are assembled into said container by the consumer.
